(19) United States
(12) Patent Application Publication
(10) Pub. No.: US 2016/0228761 A1
(43) Pub. Date: Aug. 11, 2016

(54) CASINO TABLE THREE-CARD POKER WAGERING EVENT WITH PLAYING CARDS

(71) Applicant: Jeffery J. Hwang, Henderson, NV (US)

(72) Inventor: Jeffery J. Hwang, Henderson, NV (US)

(21) Appl. No.: 14/620,158

(22) Filed: Feb. 11, 2015

(51) Int. Cl. A63F 1/00; G07F 17/32

(52) U.S. Cl. CPC A63F 1/00; G07F 17/3293; A63F 2001/005

(57) ABSTRACT

A generic method of performing a wagering event includes:
a player position posting an ante wager;
the player position is dealt two to three face-down cards;
a dealer position is dealt at least three down cards and no more than four down cards, and up to one up card;
a second wager is posted at the player position or the player position hand folds;
sufficient community cards are dealt for use by the player position to complete a three-card stud poker hand from a best-of-four, best-of-five, or best-of-six total playing cards; and
the respective best player position hands and dealer position hands are compared;
the respective poker rank at the player position is compared with a paytable to determine resolution of all wagers against the paytable.

### BACKGROUND OF THE INVENTION

### 1. Field of the Invention

The present invention relates to the field of casino wagering events, such as poker wagering events at a casino gaming table. Variations of three-card poker may be used as base wagering events.

Three-Card Poker™ games, has been one of the more successful poker variant games used in the gaming industry. A first document on this technology is found in U.S. Pat. No. 5,685,774 (Webb) which discloses card-type games that provide at least one player with the option of wagering against either a predetermined payout schedule, a dealer's hand, or both. According to another aspect, each player is provided with a wild card which is retained and used repeatedly by a player in each hand. The wild card may take a novel promotional form and is preferably more durable than the standard playing cards.

Other three-card game variants are described, for example, in U.S. Pat. Nos. 6,012,719; 6,237,916; 6,345,823; 6,371,867; 6,503,145; 6,547,246; 6,698,759; and 7,584,967.

Additional variations in the play of three-card poker (high hand and low hand) are desirable in the industry.

### SUMMARY OF THE INVENTION

A generic method of performing a wagering event includes:
a player position posting an ante wager;
the player position is dealt at least two and no more than four face-down cards;
a dealer position is dealt at least three down cards and no more than 4 down cards, and one up card;
a second wager is posted at the player position or the player position hand folds;
sufficient community cards are dealt for use by the player position to a) complete a three-card stud poker hand from a best-of-four, best-of-five, or best-of-six total playing cards; and
the respective best player position hands and dealer position hands are compared;
the respective poker rank at the player position is compared with a paytable to determine resolution of all wagers against the paytable.

### BRIEF DESCRIPTION OF THE FIGURES

FIG. 1 (Prior Art) shows a standard video game apparatus useful in enabling the present technology.

FIG. 1A (PRIOR ART) shows a gaming network that may be used to implement some aspects of the invention.

FIG. 1B (PRIOR ART) illustrates an example of a network device that may be configured for implementing some methods of the present invention.

### DETAILED DESCRIPTION OF THE INVENTION

A method of performing a generic wagering event includes:
providing a randomized set of a single deck of at least 52 playing cards; A standard deck of 52 playing cards may be used. The deck(s) may include one or more jokers or wild cards, which changes the game from stud to a wild card game.
a player position posting an ante wager;
the player position with an ante wager is dealt at least two (and no more than four) playing cards for a wagering event using a best three-card poker hand rank from a total of four, five, or six playing cards;
a dealer position is dealt at least three (and no more than four) down cards, and in both cases there may be an additional dealer position one up card in addition to the down cards;
a second wager is posted at the player position after the down cards are provided at the player position or the player position hand folding;
if a second wager has been posted at the player position, sufficient community cards are dealt for use by the player position to a) at least complete a three-card stud poker hand or best of three-card poker hands from a total of four, five, or six total playing cards when two cards are dealt face down. In a best-three of four, of-five, or of-six game, sufficient community cards to assure that a total of four, five, or six player position useful cards are provided. With an initial two-card player position hand, two or three community cards are provided for a best-of-four, best-of-five, or best-of-six cards, respectively. In a), a standard three-card poker rank with cards at the player position are compared with a (best three-card poker rank out of four or five cards, where cards play themselves) standard three-card poker rank at the dealer position, respectively. Additional wagers, including separate bonus wagers may also be placed at various times during execution of the wagering event;

Only if the respective poker rank at the player position at least equals (or preferably exceeds) the respective poker rank at the dealer position, the respective poker rank at the player position is compared with a paytable to determine resolution of all wagers against the paytable. In the case of a tie, all wagers (except possibly bonus wagers) may be a push, or possibly only the ante wager may be paid at 1:1 odds when there is a tie.

The method may be practiced where in a), the poker rank at the player position is compared with a paytable to determine resolution of all wagers against the paytable only if the respective poker rank at the player position at least exceeds the respective poker rank at the dealer position. Respective is used here to mean that both the player position and dealer position are engaged in the same number-of-cards poker, such that a best three-card poker rank with cards at the player position is playing against the best three-card poker rank with cards at the dealer position, regardless of the number of cards used to complete a three-card poker hand at each position.

The method may be practiced wherein all community cards are provided after the second wager has been placed. The method may be practiced wherein a first community card is provided after the second wager has been posted and a third wager may be posted at the player position. A first community card may be provided after the second wager has been posted and a third wager may be posted at the player position. The player may check after the first community card has been provided and remain active in the method.

The method may be practiced wherein a first community card is provided after the second wager has been posted and a third wager may be posted at the player position before final resolution of the wagering event. The method may be practiced wherein the second wager in any of the wagering events may have a value between 1× and 5× the ante wager. The method may also be practiced wherein the third wager may have a value between 1× and 5× the ante wager.

The method may be practiced wherein after a player position poker hand rank is determined to be higher than the dealer position hand rank, a final player position poker hand rank in excess of a predetermined minimum rank, such as at least three-of-a-kind, at least a straight, or at least a flush is awarded a bonus payout on the ante wager.

Within the generic concepts of the present technology, there are three sub-species that are included within that generic concept. These sub-specie variants can be referred to and sub-generically described as follows:

1. Three Card Stud Triple Draw. Player position is dealt two down cards and three community cards, and must use both hole cards and one community card to make the best three-card poker hand he can make. The dealer position is dealt three down cards and a fourth card, preferably as one up card.
2. Super Three Card Stud. Player position is dealt two down cards and two community cards, and best three-of-four play. Dealer position is dealt three down cards and a fourth card, one up card. In a preferred variant, the player position must use both down cards in any final three-card poker hand formed in resolving the wagers.
3. Variations 3 and 4. Player position is dealt three down cards and three community cards, making best three-card poker hand the player position can make using two hole cards and one community card. In Variation 3, the player discards one card prior to the community cards being revealed; in Variation 4, cards speak for themselves, and preferably at least two hole cards must be used in forming the final three-card poker hand (alternatively, the player must discard one card and set his own hand).

In play of the game, it may be desirable for the house to require that in any wager resolution and setting of hands, all down cards, all but one, all but two face-down cards must be used in a final hand, or any other variation in required numbers of face-down cards or allow for complete player selection of cards. Therefore in a three-card wagering event, where two cards are originally dealt face down, all two of the face-down cards might be required to be used by the player position in determining a final hand rank. Although not required, the dealer position might be required to use the face-up card in any final hand.

Two preferred variations of the method may be practiced a) wherein exactly two cards are dealt face down and there are exactly three community cards provided before resolution of all wagers, and the player must use both face down cards with one of the three community cards in order to form the best three-card poker hand; the dealer receives three down cards and one up card for a total of four cards with which to form a best-of-four three-card poker hand; and b) wherein the player position is dealt exactly two cards face down, exactly two community cards are dealt before all wagers are finally resolved, and the player can use any combination of the two hole cards and two community cards in order to form a best three of four poker hand; the dealer again receives three down cards and one up card to form a best-of-four three-card poker hand.

Three Card Stud Triple Draw™ Wagering Event (or Super Stud Triple Draw™ Wagering Event)

Three Card Stud Triple Draw™ wagering event is a three-card stud game in which the player starts with two hole cards and draws three community cards, one of which will be used to complete the best three-card poker hand the player can make using both of his hole cards. The dealer is dealt one up card and three down cards (four cards total), and plays the best three-out-of-four for his three-card poker hand.
1. Player posts ante and option 5-Card Hand sidebet wager.
2. Dealer is dealt one up card and three down cards. Player is dealt two down cards.
3. 3^{rd} Street. Player can bet 1×-3× or fold.
4. If player bets, the dealer reveals three community cards, one of which will be used to complete the player's three card hand.
5. Showdown. The player's hand is the best three-card poker hand he can make using his two hole cards and one of the three community cards. The dealer's hand is the best three-out-of-four in his hand.
6. If the player makes a pair-or-better and wins (or alternatively, merely beats the dealer), he is paid according to a pay table.

The 5-Card Hand sidebet may be a bet for certain five-cards hands the player makes using his two hole cards and three community cards. Below is a sample pay table.

### 5-Card Hand Sidebet

| Hand | Payoff |
|---|---|
| Royal Flush | 500 to 1 |
| Straight Flush | 200 to 1 |
| Quads | 50 to 1 |
| Full House | 25 to 1 |
| Flush | 20 to 1 |
| Straight | 15 to 1 |
| Trips | 5 to 1 |
| Two Pair | 2 to 1 |
| Jacks or Better | 1 to 1 |
| 22-TT | Push |

When wild cards or low-poker hand ranks may be used as wagers, the paytable may vary. There may be a separate side bet on a low hand, which can keep players in a hand longer than their potential high poker hand ranks may be effectively do. For example, a player hand of 2, 4, 6, 8 may be enticed to stay in a hand when there is a low hand rank bonus wager, which might pay as much as 50:1, even though the player positions loses a high poker hand rank. This could occur even where the player position must place wagers on the high rank competition with little likelihood of winning the high rank event.

### Super Three Card Stud™ Wagering Event

Super Three Card Stud is a four-card stud game in which the player is dealt two hole cards and two community cards to complete a three-card poker hand. Cards speak, and any combination of three cards plays.

There is one betting round after the initial two cards are dealt.
1. Player posts ante and optional 4-Card Hand sidebet wager.
2. Dealer receives three down cards and one up card.
3. Player is dealt two down cards.
4. 3^{rd} Street. Player can bet 1×-3× or fold.
5. If the player bets, the dealer reveals two community cards to be shared by the players to form the best three-card poker hand.
6. Showdown. Best three-out-of-four hand plays. In the preferred version, the player must make a pair-or-better and beat the dealer.
7. If the player beats the dealer, the player is paid according to a pay table.

The 4-Card Hand sidebet is a bet on four-card poker hands utilizing both player hole cards and both community cards.

### 4-Card Hand Sidebet

| Hand | Payoff |
|---|---|
| Quads | 500 to 1 |
| 4-Card Straight Flush | 200 to 1 |
| 4-Card Flush | 10 to 1 |
| 4-Card Straight | 10 to 1 |
| Trips | 5 to 1 |
| Two Pair | 2 to 1 |
| Pair | 1 to 1 |

### Variations III and IV

In a third and fourth variations, the player position is dealt three down cards and three community cards, for a total of six cards from which to form the best three-card poker hand the player position can make, preferably being required to use two hole cards and one community card.

In Variation III, the player position must discard one of the three initial face down cards after posting a second wager, but prior to the revealing of any community cards. The dealer position is dealt three down cards and one up card, for a total of four cards from which to form a best-of-four three-card stud poker hand, and the dealer position is preferably not required to use then up card in forming a best three-card poker hand.

In Variation IV, the player position keeps all three down cards until all community cards are dealt. In this variation, cards may speak; alternatively, the player position may be required to discard the unused third card (preferably before the community cards are viewed), thus setting his own hand. In contrast to Variation III, the dealer position is dealt four down cards and one up card, for five cards total with which to form a best-of-five three-card stud poker hand. Again, the dealer position preferably need not be required to use the up card in the setting of the three-card poker rank for the dealer position.

### Lowball

Low-ball variants of the generic concepts of wagering events and each of the above specie variants may be practiced. In a low-hand variant, a method of performing a wagering event may include:
providing a randomized set of a single deck of at least 52 playing cards;
a player position posting an ante wager;
   the player position with an ante wager is dealt at least two and no more than three face-down playing cards;
   a dealer position is dealt at least three down cards and no more than 5 total playing cards with no more than 4 down playing cards;
   a second wager being posted at the player position or the player position hand folding;
   if a second wager has been posted at the player position, sufficient community cards are dealt for use by the player position to a) complete a best of four, best of five, or best of six playing cards three-card stud poker hand;
   in a), standard three-card poker rank with cards at the player position are compared with standard three-card poker rank at the dealer position, respectively;
   only if the respective poker rank at the player position at most equals or is lower than the respective poker rank at the dealer position, the respective poker rank at the player position is compared with a paytable to determine resolution of all wagers against the paytable.

In the low hand rank variant, there may be a bonus event added for a high hand rank of the same size (3-card). In the bonus events, it may be possible to use fewer than all face-down cards. Any bonus paytable would reflect the number of face-down cards that must be used in any final resolution of the wager. The fewer the number of face-down playing cards that must be used, the lower the odds are likely to be in the paytable.

### Wagering Game Machine Architectures

Prior Art wagering game machine architecture may be used to effect and practice example embodiments of the invention. A typical wagering game machine architecture includes a wagering game machine or terminal or bank of machines, which includes a central processing unit (CPU) connected to main memory. The CPU can include any suitable processor, such as an Intel™ Pentium processor, Intel® Core 2 Duo processor, AMD Opteron® processor, or Ultra SPARC processor. The main memory includes a wagering game unit and a wagering game animation presentation unit. In one embodiment, the wagering game unit can present the wagering games described herein, in whole or part.

The wagering game animation presentation unit receives wagering game animations generated by a content server (e.g., the content server described above) and presents the wagering game animations on a primary display and/or a secondary display of the wagering game machine in accordance with instructions from a content server. In some implementations, the main memory may also comprise a compositing unit. The compositing unit can receive, from the content server, a template animation, a randomly generated wagering game outcome, and an orientation of an object(s) of the wagering game. The compositing unit can generate the wagering game animation and present the wagering game animation (e.g., spinning wheels or other added animation) on the primary display and/or the secondary display of the wagering game machine based on the template animation, the outcome, and the orientation of the object(s).

The CPU is also connected to an input/output (I/O) bus, which can include any suitable bus technologies, such as an AGTL+ frontside bus and a PCI backside bus. The I/O bus is connected to a payout mechanism, the primary display, the secondary display, value input device, player input device, information reader, and storage unit. The player input device can include the value input device to the extent the player input device is used to place wagers. The I/O bus is also connected to an external system interface, which is connected to external systems (e.g., wagering game networks).

In one embodiment, the wagering game machine can include additional peripheral devices and/or more than one of each component discussed above. For example, in one embodiment, the wagering game machine can include multiple external system interfaces and/or multiple CPUs. In one embodiment, any of the components can be integrated or subdivided.

Any component of the architecture can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). Machine-readable media can be machine-readable storage media or machine-readable signal media. Examples of machine-readable storage media include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Examples of machine-readable signal media can be in the form of an electro-magnetic signal, an optical signal, or any suitable combination thereof.

A graphical user interface (GUI) is a type of computer application user interface that allows people to interact with a computer and computer-controlled devices. A GUI typically employs graphical icons, visual indicators or special graphical elements, along with text, labels or text navigation to represent the information and actions available to a user. The actions are usually performed through direct manipulation of the graphical elements.

A gaming apparatus may include a housing, a display system for providing at least one payline for a wagering game, with multiple symbols available for each frame of the at least one payline, a processor and a wager accounting system, wherein the processor is configured to execute code to perform the wagering methods described herein. The game may also be played on-line, with a central and distal server providing gaming content on-line or through a large area network (LAN) or wide area network (WAN). Player input systems may include any hardware capable of accessing the network and having capability of security supervision, such as smart phones, pads, tablets, processor systems (e.g., laptops, desktop, or hand-held computer systems) and the like.

A brief description of an example of a method of practicing the present technology will assist in a further understanding of the technology and its scope.

There are many structural options for the sequential display of symbols in the structure of the present technology. As noted herein, certain orientations of original display of frames according to the present technology may or may not provide different quality of information affecting probabilities and decisions. Keeping that important impact of disclosure in mind, there are still neutral mechanisms according to the present technology.

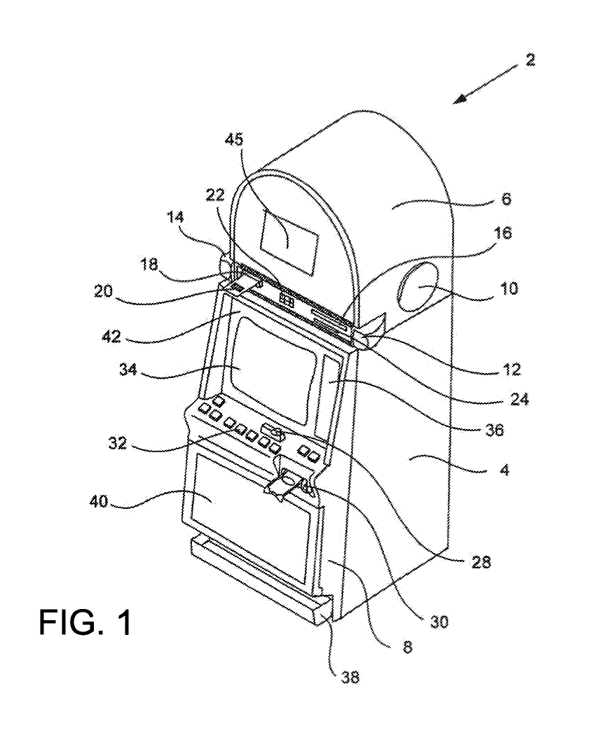

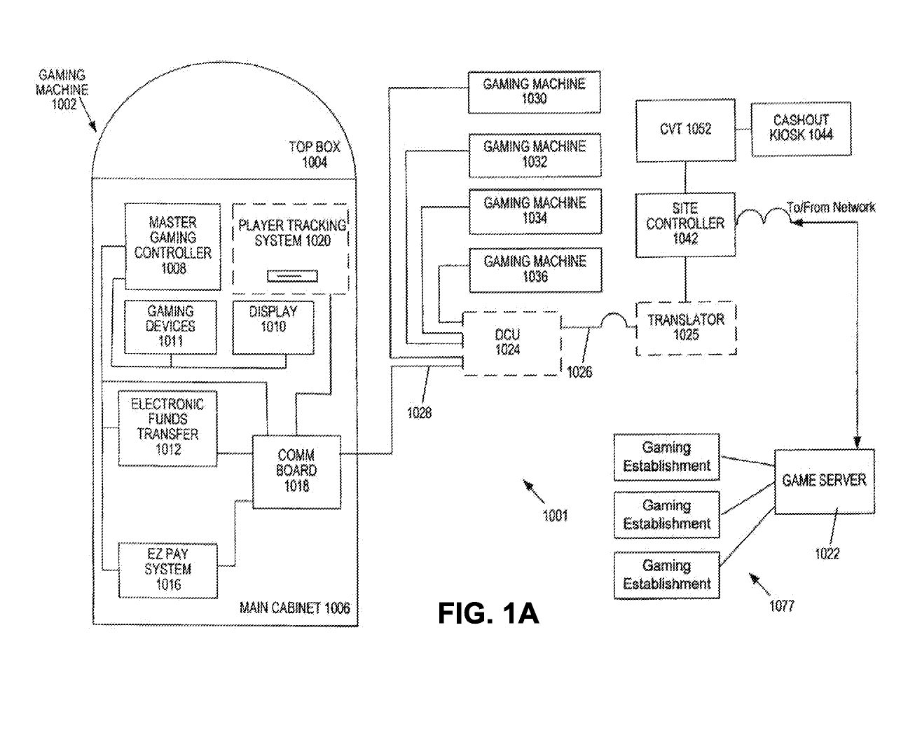

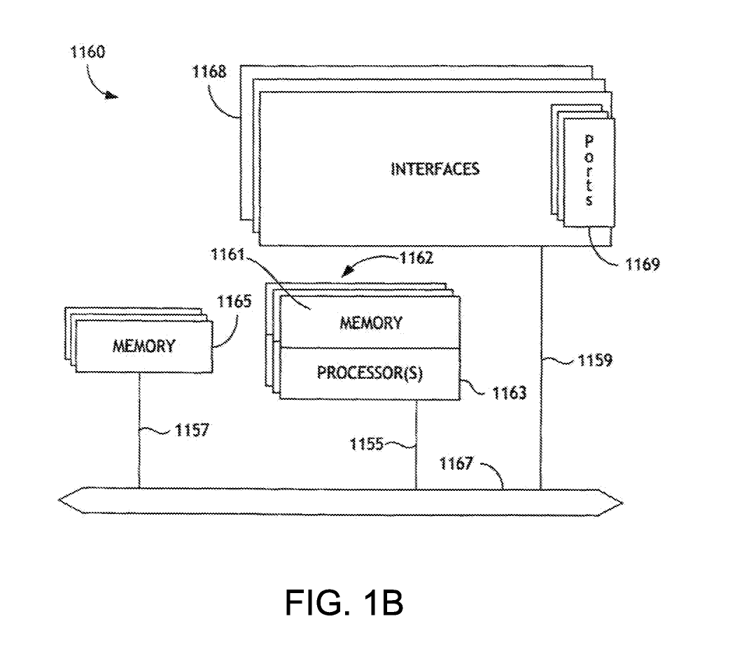

Turning next to FIG. 1, a video gaming machine 2 of the present invention is shown, Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit, Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1), The bill validator 30, player-input switches 32, video display monitor 34, and information panel are devices used to play a game on the game machine 2. The devices are controlled by circuitry the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device, Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may he greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software, Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc, that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” ETA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system 1016 (a proprietary cashless ticketing system of the present assignee), and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

The basic equipment desirable for performing the process and forming the system may include:
a) a processor configured to execute code to simulate a physical random gaming event outcome using a random number generator. A commercially available gaming processor or central processor may be used. The processor may be provided with memory, flash memory, EPROM, EEPROM, RAM, ROM, input/output ports, hard-wire or wireless communication enabling capability and the like.
b) memory storing video displayable image data of a device useful in providing the physical random gaming event outcome. The displayable image data may be segmented or may be in a continuous format. In segmented format, a first generic image data set would display a generic movement of the virtual random event generations system would be shown. An individual, specific segment may be transferred from memory to the display system at the end of the generic segment. The individual, specific display data segment would then show the virtual image of the random number generated determined outcome for the game event. This method reduces the total amount of data that must be stored in displaying outcomes. This is particularly important where a single processor stores multiple games thereon.

The present gaming technology may also be implemented for on-line gaming, social media play or gaming, communal gaming, multi-player platform gaming and the like. As the only change implemented by players during the game is wagering amounts, as opposed to play strategy, allowing multiple players to engage in a single game is easily enabled.

The technology disclosed herein may also be used in social media applications, with no wagers, or virtual wagers used in social media game play or free play on free-gaming websites. As on-line gaming becomes available, this technology may be incorporated therein also, using existing or improved future technology implementing the wagering steps disclosed herein.

Other variations may be useful and added to the generic concept within the scope of the invention. For example, specific markings may be on the table for initial player cards, each individual or collective community cards, specific marked areas for each possible wager, including bonus wagers, and the like.

What is claimed:

1. A method of performing a wagering event comprises:
a) providing a randomized set of a single deck of at least 52 playing cards;
b) a player position posting an ante wager;
c) the player position with an ante wager is dealt at least two and no more than three face-down cards;
d) a dealer position is dealt at least three down cards and no more than four down cards, and one up card;
e) a second wager is posted at the player position or the player position hand folding;
f) if a second wager has been posted at the player position, sufficient community cards are dealer for use by the player position to i) complete a three-card stud poker hand with a best-of-four, best-of-five, or ii) best-of-six total playing cards when two or three cards are dealt face down;
g) in a), standard three-card poker rank with cards at the player position are compared with standard three-card poker rank at the dealer position, respectively;
h) only if the respective poker rank at the player position at least equals the respective poker rank at the dealer position, the respective poker rank at the player position is compared with a paytable to determine resolution of all wagers against the paytable.

2. The method of claim 1 wherein all playing cards are physical playing cards in i) or ii) the poker rank at the player position is compared with a paytable to determine resolution of all wagers against the paytable only if the respective poker rank at the player position at least exceeds the respective poker rank at the dealer position.

3. The method of claim 1 wherein all community cards are provided after the second wager has been placed.

4. The method of claim 2 wherein all community cards are provided after the second wager has been placed and at least two face-down cards must be used at the player position in determining three-card poker rank at the player position.

5. The method of claim 1 wherein a first community card is provided after the second wager has been posted and a third wager may be posted at the player position and at least two face-down cards must be used at the player position in determining three-card poker rank at the player position.

6. The method of claim 2 wherein a first community card is provided after the second wager has been posted and a third wager may be posted at the player position and at least two face-down cards must be used at the player position in determining three-card poker rank at the player position.

7. The method of claim 5 wherein the player may check after the first community card has been provided and remain active in the method.

8. The method of claim 6 wherein the player may check after the first community card has been provided and remain active in the method.

9. The method of claim 1 wherein in b), the player position is dealt two face-down physical playing cards and there are three community physical playing cards.

10. The method of claim 9 wherein the three-card poker rank at the player position is compared with a paytable to determine resolution of all wagers against the paytable only if the three-card poker rank at the player position at least exceeds the three-card poker rank at the dealer position.

11. The method of claim 9 wherein all community cards are provided after the second wager has been placed.

12. The method of claim 10 wherein all community cards are provided after the second wager has been placed and at least two face-down cards must be used at the player position in determining three-card poker rank at the player position.

13. The method of claim 9 wherein a first community card is provided after the second wager has been posted and a third wager is posted at the player position before final resolution of the wagering event.

14. The method of claim 10 wherein a first community card is provided after the second wager has been posted and a third wager is posted at the player position before final resolution of the wagering event.

15. The method of claim 9 wherein the player may check after the first community card has been provided and remain active in the method.

16. The method of claim 2 wherein the second wager has a value between 1× and 5× the ante wager.

17. The method of claim 9 wherein the second wager has a value between 1× and 5× the ante wager.

18. The method of claim 10 wherein the second wager has a value between 1× and 5× the ante wager.

19. The method of claim 1 wherein after a player position poker hand rank is determined to be higher than the dealer position hand rank, a final player position poker hand rank in excess of one pair is awarded a bonus payout on the ante wager.

20. The method of claim 2 wherein after a player position poker hand rank is determined to be higher than the dealer position hand rank, a final player position poker hand rank in excess of a pair of Queens is awarded a bonus payout on the ante wager.

21. The method of claim 9 wherein after a player position poker hand rank is determined to be higher than the dealer position hand rank, a final player position poker hand rank in excess of a specific predetermined pair rank is awarded a bonus payout on the ante wager.

22. The method of claim 2 wherein exactly two cards are dealt face down and there are exactly three community cards provided before resolution of all wagers.

23. The method of claim 2 wherein in a) the three-card poker rank at the player position is compared with a paytable to determine resolution of all wagers against the paytable only if the three-card poker rank at the player position at least exceeds the three-card poker rank at the dealer position.

24. A method of performing a wagering event comprises:
providing a randomized set of a single deck of at least 52 playing cards;
a player position posting an ante wager;
the player position with an ante wager is dealt at least two and no more than three face-down playing cards;
a dealer position is dealt at least three down cards and no more than 5 total playing cards with no more than 4 down playing cards;
a second wager being posted at the player position or the player position hand folding;
if a second wager has been posted at the player position, sufficient community cards are dealer for use by the player position to a) complete a best of five, or b) best of four playing cards three-card stud poker hand;
in a), standard three-card poker rank with cards at the player position are compared with standard three-card poker rank at the dealer position, respectively;
only if the respective poker rank at the player position at most equals or is lower than the respective poker rank at the dealer position, the respective poker rank at the player position is compared with a paytable to determine resolution of all wagers against the paytable.

25. A method of performing a wagering event comprises:
providing a randomized set of a single deck of at least 52 playing cards;
a player position posting an ante wager;
the player position with an ante wager is dealt exactly two face-down playing cards;
a dealer position is dealt exactly three or four face-down cards and no more than 1 up card;
a second wager being posted at the player position or the player position hand folding;
if a second wager has been posted at the player position, sufficient community cards are dealer for use by the player position to a) complete a best of five, best of four playing cards three-card stud poker hand;
in a), standard three-card poker rank with cards at the player position are compared with standard three-card poker rank at the dealer position, respectively;
only if the respective poker rank at the player position at most equals or is lower than the respective poker rank at the dealer position, the respective poker rank at the player position is compared with a paytable to determine resolution of all wagers against the paytable.
